(19) United States
(12) Patent Application Publication
(10) Pub. No.: US 2006/0032874 A1
(43) Pub. Date: Feb. 16, 2006

(54) Vehicle valet rack

(76) Inventor: Karl Pansewicz, Harvard, MA (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/916,820

(22) Filed: Aug. 12, 2004

(51) Int. Cl. B62D 43/00

(52) U.S. Cl. 224/42.13

(57) ABSTRACT

A vehicle valet rack removeably mountable on a tire of a vehicle to support an elongated item, the other end of which is supported on a ground surface, including a mounting bracket mountable on an outward face of the tire and a support member extending upwardly from the mounting bracket. The support member includes a horizontally extending rake bar spaced outwardly from and parallel to a side of the vehicle that includes a plurality of horizontal tines spaced along and extending outwardly from the rake bar to engage with and retain an upper section of the item. The mounting bracket includes a generally U-shaped adjustable horizontal mounting member to horizontally position the mounting bracket and a generally U-shaped adjustable vertical mounting member that supports the mounting bracket vertically.

### FIELD OF THE INVENTION

The present invention relates to a vehicle valet rack accessory for holding and supporting items, for example, sporting goods such as skis and skateboards, while loading or unloading the vehicle.

### BACKGROUND OF THE INVENTION

It is very common while loading or unloading a vehicle such as a car, SUV or van to have to rest various items in some convenient place and many such items, such as boxes, dufflebags, suitcases, and so on, can be simply placed on the ground, for example, or some form of carrier or platform. Other items, however, such as sporting equipment like skis, skateboards, baseball bats, hockey equipment, fishing gear, golf clubs, rakes, shovels and brooms are more awkward in that they are preferably placed in an upright position, but have a strong tendency to fall over, possibly scratching or denting the vehicle or the person loading or unloading the vehicle.

There are a number of problems with conventionally designed racks and similar arrangements attached to or built into the vehicle, however. For example, such racks or devices are needed and convenient only part of the time, and are generally awkward and take up space that is more often useful for other purposes the rest of the time. Also, if such a rack or device is designed to fold out of the way, it will typically be complex, expensive and very breakable.

The present invention addresses and provides a solution for these and other related problems of the prior art.

### SUMMARY OF THE INVENTION

The present invention is directed to a vehicle valet rack that is removeably mountable on a tire of a vehicle to support an elongated item, the other end of which is supported on a ground surface in a generally upright position.

The rack includes a mounting bracket removeably mountable on an outward face of the tire and a support member extending upwardly from the mounting bracket.

The support member includes a horizontally extending rake bar that is spaced outwardly from and parallel to a side of the vehicle at the upper end of the support member and that includes a plurality of horizontal tines spaced along and extending outwardly from the rake bar to engage with and retain an upper section of the item.

The mounting bracket includes a generally U-shaped adjustable horizontal mounting member and a generally U-shaped adjustable vertical mounting member. The horizontal mounting member positions the mounting bracket horizontally and includes a first segment extending horizontally across the face of the tire and opposing second segments, one of which is adjustable in length, that engage opposing points on the circumference of the tire and that extend across a part of a tread of the tire. The vertical mounting member positions the mounting bracket vertically on the face of the tire and includes a first segment extending vertically to an upper circumference of the tire, a second segment that is adjustable in length and that extends across the tread of the tire, and a third segment that extends across a part of a back face of the tire to retain the mounting bracket against the outward face of the tire.

### BRIEF DESCRIPTION OF THE DRAWINGS

The foregoing and other objects, features and advantages of the present invention will be apparent from the following description of the invention and embodiments thereof, as illustrated in the accompanying figures, wherein:

FIGS. 1A and 1B are isometric views illustration a valet rack with a support member and a mounting bracket;

FIG. 2 is an isometric view of a mounting bracket of a valet rack; and,

FIG. 3 is an isometric view of a support member of a valet rack.

### DETAILED DESCRIPTION OF THE INVENTION

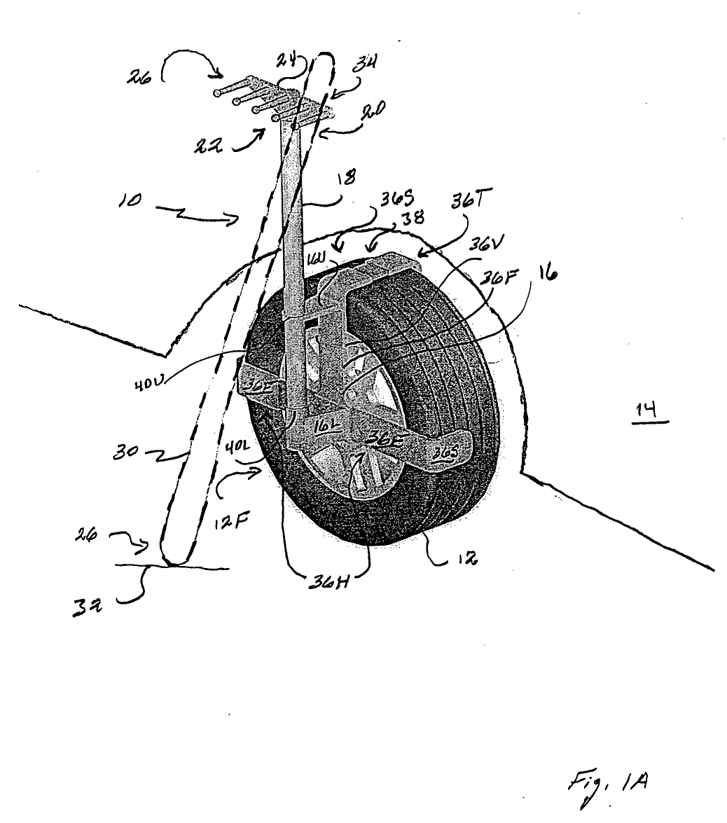

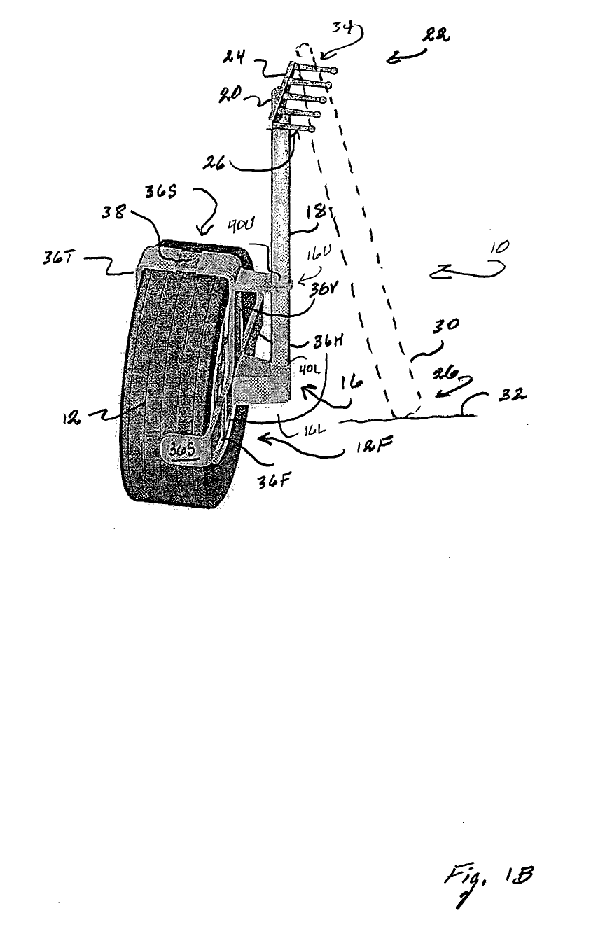

Referring to FIGS. 1A and 1B, therein are shown diagrammatic isometric representations of, respectively, a quarter front view and a general side view of a Valet Rack 10 of the present invention.

As illustrated therein, a Valet Rack 10 is removeably mountable on a Tire 12 of a Vehicle 14 by means of a Mounting Bracket 16 that is removeably mounted on an outward Face 12F of the Tire 12 and includes a Support Member 18 that extends upwards from Mounting Bracket 16. Upper End 20 of Support Member 18 includes a Retaining Rake 22 having a Rake Bar 24 that extends horizontally and generally parallel with the side of Vehicle 14 and includes a plurality of outwardly extending and generally horizontal Tines 26 spaced along the length of Rake Bar 24.

As generally illustrated by phantom lines in FIGS. 1A and 1B, a Lower End 28 of an Item 30 to be supported by the Valet Rack 10, such as skis or a skateboard, is placed on a Ground Surface 32 in the area of Valet Rack 10, and preferably spaced outwards somewhat from Valet Rack 10, and an Upper Section 34 of the Item 30 is engaged with Valet Rack 10 by placing the Upper Section 34 between two Tines 26.

It will therefore be apparent that an elongated Item 30 will be restrained and supported in a generally upright position with one end on the ground and the portion of the item adjacement Retaining Rack 22 engaged between Tines 26 until the Item 30 is removed from that position. In particular, Upper Section 34 of the Item 30 will be restrained from sliding or falling sideways, that is, along a path parallel to the side of the Vehicle 14, by the Tines 26 and the inward lean of the Item 30 due to spacing Lower End 28 of the Item 28 outwards from the Valet Rack 10 will inhibit the Item 30 from falling outwards from between the Tines 26.

In a typical embodiment such as for skis or skateboards, Support Member 18 may be on the order of one and a quarter feet long, for each of storage, and may be extensible to approximately three feet long so to place Rake Bar 24 at a suitable distance above the Ground Surface 32 when the Valet Rack 10 is mounted on a typical Tire 12. Rake Bar 24, in turn, and for skis or skateboards, may be on the order of 1.5 feet wide and 4 inches thick and may include 6 tines 26 spaced apart by approximately 3 inches, where Tines 26 may each have a length in the order of 4 inches and a diameter on the order of 0.5 inches. As shown, Tines 26 may also have enlarged outer Ends 26E, which may be, for example, disk, ball or ovoid shaped, to assist in retaining Items 30 in the spaces between Tines 26.

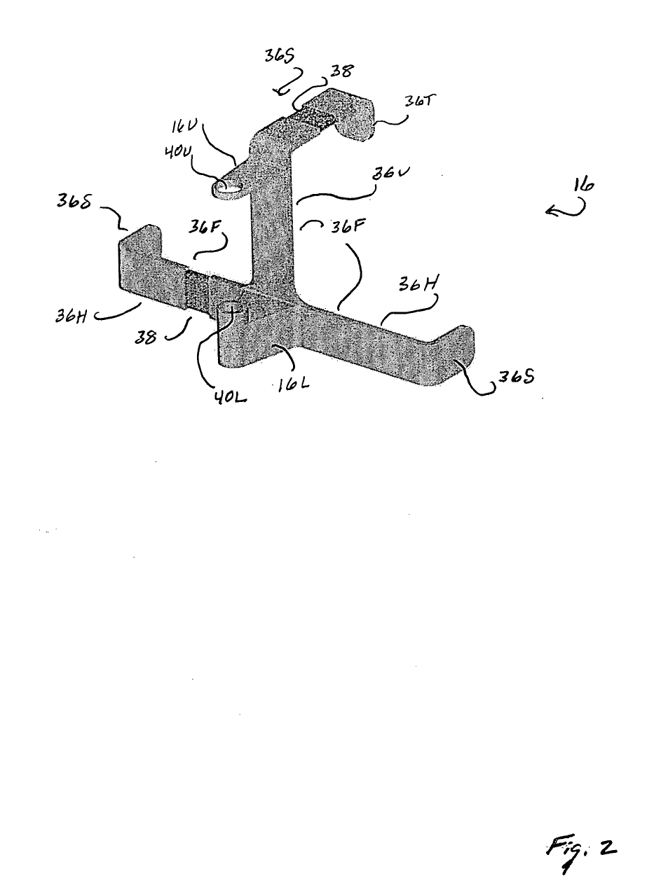

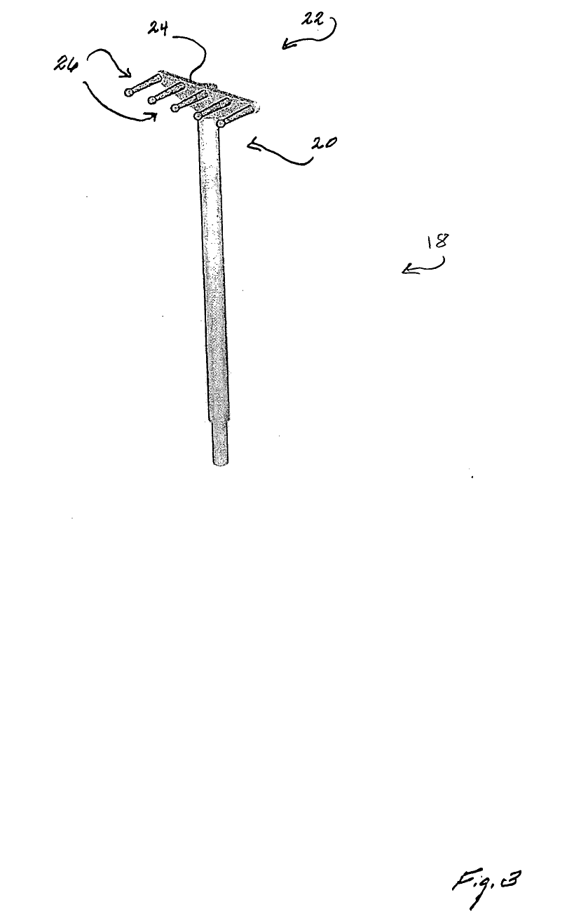

Next considering Mounting Bracket 16 further detail, as illustrated FIGS. 1A, 1B and 2, Mounting Bracket 16 removeably mounts a Valet Rack 10 to a Tire 12 of a Vehicle 10 by means of a horizontal Mounting Arm 36H and a vertical Mounting Arm 36V. As shown, horizontal Mounting Arm 36H is generally U-shaped with a First Segment 36F extending horizontally across a chord or diameter of Tire 12 from a common center of Mounting Arm 36H and Mounting Arm 36V. Opposing Second Segments 36S, which comprise the vertical side bars of the general U-shape, then extend at right angles to the First Segments 36F and across a part of the tread of the Tire 12, so that horizontal Mounting Arm 36H holds Mounting Bracket 16 in a position centered on a vertical centerline of Tire 12 with Second Segments 36S preventing excessive sidewise motion of the Mounting Bracket 16. In a typical embodiment, Mounting Bracket 16 will accomodate a Tire 12 having diameter in the range of 25 inches, thereby accomodating a typicaly Tire 12 of an average conventional street vehicle, but as described below, is designed to adapt to a range of larger or smaller tires and may further include adjustments to allow the lengths of Mounting Arms 36V and 36H to be adjustable.

Vertical Mounting Arm 36V extends upwards from the common center of Mounting Arms 36H and is generally U-shaped, with a First Segment 36F extending vertically from the common center of Mounting Arms 36H and 36V to the outside, or front, circumference of the Tire 12. The Second Segment 36S then extends at a right angle to First Segment 36F and across the tread of Tire 12 to the inside, or back, circumference of the Tire 12, at which point a Third Segment 36T extends downwards for a relatively short distance at a right angle to Second Segment 36S, thereby completing the U-shape. It will therefore be apparent that First Segment 36F of Mounting Arm 36V establishes the vertical location of Mounting Bracket 36 with respect to Tire 12, Second Segment 36S supports Mounting Bracket 36 at that location, and Third Segment 36R prevents Mounting Bracket 36 from sliding forwards off of the Tire 12.

Further in this regard, it must be noted that Second Segment 36S of Mounting Arm 36V will typically include a Tire Width Adjustment 38 for adjustment of the horizontal length of the Second Segment 36S of Mounting Arms 36V to the tread width of Tire 12, thereby allowing Mounting Bracket 16 to be ajdusted for secure mounting on a variety of tires of different sizes. Tire Width Adjustment 38 may be implemented in any of a number of ways, and will probably include a telescoping section permitting the length of Second Segment 36S to be lengthened or shortened and a fastener to lock the length once adjusted. The lock, in turn, may be, for example, a friction fit, an elastic or resilient spring or cord to resiliently bias the two ends of Second Segment 36S towards each other, or a rack and pinion device for concurrently adjusting and locking the length.

It should also be noted that width or length adjustors will typically not be required on either or both of the Mounting Arms 36H as the degree of restraint provided of Mounting Arms 36H is not as close as that required of Mounting Arm 36V and fixed length Mounting Arms 36H will typically provide an adequate fit to a large range of Tires 12. It will be understood, however, that such length or width adjustors may be readily added to one or both of Mounting Arms 36H if deemed necessary.

As shown in FIGS. 1A, 1B and 2, Mounting Bracker 16 further includes an Upper Bracket 16U and a Lower Bracket 16L for receiving and supporting Support Member 18 in the upright position and spaced outwardly from Mounting Bracket 16 so that Upper Section 34 of an Item 30 is spaced outward from a Vehicle 14 so as not to bear agains the Vehicle 14. In a typical embodiment, for example, Support Member 18 may be supported outwardly by a distance in the range of 4 to 8 inches, so that Mounting B racket 16 can be mounted on a Tire 12 that is recessed into a wheel well by an average of 4 inches while allowing a clearance in the range of 4 inches between Retaining Rack 22 and Item 30 and the side of Vehicle 12.

As shown, Upper Bracket 16U has an Upper Opening 40U shaped to receive a Mating Section 16UM of Support Member 18 and Lower Bracket 16L has a corresponding Lower Opening 40L to receive a Mating Section 16LM of Support Member 18. In a present embodiment, those portions of Support Member 18 mating with Upper Bracket 16U and Lower Bracket 16L are of generally circular cross section, as are Upper Opening 40U and Lower Opening 40L. It will be appreciated that when Support Member 18 may be engaged with Upper Bracket 16U and Lower Bracket 16L in a number of ways to locate and restrain the Support Member 18 in the vertical direction with respect to Mounting Bracket 16. For example, one or both of Mating Sections 16UM and 16LM may include a collar having a greater diameter than the corresponding Upper Opening 40U and Lower Opening 40L, or there may be a change in the diameter of Support Member 18 at one or both of Mating Sections 16UM and 16LM, or the lower end of Lower Opening 40L may be closed to provide a stop and support for the lower end of Support Member 18. It will also be appreciated that the cross sections of Support Member 18 and Upper and Lower Openings 40U and 40L need not be circular, but may be of another other convenient shape, such a square or polyagonal.

In a typical embodiment, Upper Bracket 16U is located in the range of 10 to 14 inches above Lower Bracket 16L, which is located at the approximate center of Tire 12, and the outward extension of Upper Bracket 16U and Lower Bracket 16L to the approximate centerlines of Upper Opening 40U and Lower Opening 40L is in the range of 4 to 6 inches to provide adequate clearance between an Item 30 and the side of a Vehicle 12, as discussed above. It will also be noted that Upper Bracket 16U is shown as a relatively flat beam-like member, while Lower Bracket 16L is shown as relatively thicker. Lower Bracket 16L will typically be comprised of a thicker member because Lower Bracket 16L is ordinarily subject to greater bending and twisting forces than is Upper Bracket 16U and, in this illustrative embodiment, is shown as having a thickness approximately the same as horizontal Mounting Arms 36H.

In a presently preferred embodiment, a Vehicle Valet 10 will be comprised of two components, the Mounting Bracket 16 and the Support Member 18, which will be separable for storage and a assembled for use. Mounting Bracket 16 and Support Member 18 will typically be comprised of a molded or cast plastic material that is of sufficient dimensions for the intended purpose and that is stable and strong over a relative wide temperature range for use in both severe winter and summer conditions. In addition, the material will typically be given a highly visible color, such as bright red-orange, to held prevent accidents when a Vehicle Valer 10 is left mounted on a Tire 12, which will often be the case for convenience when return to the vehicle carrying, for example, skis and ski poles, boots or skateboards, or other camping or sporting equipment.

It will therefore be apparent that certain changes may be made in the above described method and system without departing from the spirit and scope of the invention herein involved. For example, the arrangment of two horizontal Mounting Arms 36H and one vertical Mounting Arm 36V may be replaced by a V-shape arrangement of two mounting arms effectively suspending the Vehicle Valet 10 assembly from the upper right and upper left segments of the tire circumference. It is therefore intended that all of the subject matter of the above description or shown in the accompanying drawings shall be interpreted merely as examples illustrating the inventive concept herein and shall not be construed as limiting the invention.

What is claimed is:

1. A rack removeably mountable on a tire of a vehicle to support an elongated item supported on a ground surface in a generally upright position, comprising:
a mounting bracket removeably mountable on an outward face of the tire, and
a support member extending upwardly from the mounting bracket, including
a horizontally extending rake bar at an upper end of the support member and spaced outwardly from and parallel to a side of the vehicle, and
a plurality of horizontal tines spaced along and extending outwardly from the rake bar, wherein
the tines engage with and retain an upper section of the item, and the mounting bracket including
a generally U-shaped horizontal mounting member to position the mounting bracket horizontally on the face of the tire, including
a first segment extending horizontally across the face of the tire and
opposing second segments engaging opposing points on a circumference of the tire and extending across a part of a tread of the tire, and
a generally U-shaped vertical mounting member to support the mounting bracket on the face of the tire, including
a first segment extending vertically to an upper circumference of the tire,
a second segment extending across the tread of the tire, and
a third segment extending across a part of a back face of the tire to retain the mounting bracket against the outward face of the tire,
a lower bracket extending outwards from the mounting bracket to engage and support a lower end of the support member, and
an upper bracket extending outwards from the mounting bracket to engage and retain a mating section of the support member.

2. The rack of claim 1, wherein the second segment of the vertical mounting member further includes:
a tire width adjustment mechanism for adjusting the length of the second segment to different tires.

3. A rack removeably mountable on a tire of a vehicle to support an elongated item supported on a ground surface in a generally upright position, comprising:
a mounting bracket removeably mountable on an outward face of the tire, and
a support member extending upwardly from the mounting bracket, including
a horizontally extending rake bar at an upper end of the support member and spaced outwardly from and parallel to a side of the vehicle, and
a plurality of horizontal tines spaced along and extending outwardly from the rake bar, wherein
the tines engage with and retain an upper section of the item, and the mounting bracket including
a plurality of mounting members, each extending across at least a part of the outward face of the tire and engaging with at least a circumference of the time to support the mounting bracket at a desired position on the outward face of the tire.
